(19) United States
(12) Patent Application Publication
(10) Pub. No.: US 2006/0110198 A1
(43) Pub. Date: May 25, 2006

(54) Paper detecting device and image forming apparatus including the same

(75) Inventors: Jin-yoon Kim, Suwon-si (KR); Jae-hoon Lee, Incheon Metropolitan City (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/250,415

(22) Filed: Oct. 17, 2005

(30) Foreign Application Priority Data
Nov. 24, 2004 (KR) 10-2004-0097016

(51) Int. Cl. G03G 15/00

(52) U.S. Cl. 399/405

(57) ABSTRACT

A paper detecting device includes a paper contact arm, one side of which contacts a surface of a sheet of paper and the other side is connected to a rotating member. A sensor unit senses the rotation of the paper contact arm. An elastic member elastically biases the paper contact arm in the direction in which the paper contact arm contacts the sheet of paper. A contact force regulating unit is installed to generate a rotational force in the direction opposite to the direction of an elastic force by the elastic member. Accordingly, because the paper contact arm is returned to its initial position by the elastic member, paper jams are substantially prevented. The contact force regulating unit regulates the paper contact force within a predetermined range to avoid damage and contamination of a sheet of paper. The simple structure of the paper detecting device improves mass-production thereof.

### CROSS-REFERENCE TO RELATED PATENT APPLICATIONS

This application claims the benefit under 35 U.S.C. §119(a) of Korean Patent Application No. 10-2004-0097016, filed on Nov. 24, 2004, in the Korean Intellectual Property Office, the entire disclosure of which is hereby incorporated herein by reference.

### BACKGROUND OF THE INVENTION

1. Field of the Invention

The present invention relates to a paper detecting device and an image forming apparatus including the same. More particularly, the present invention relates to a paper detecting device that substantially prevents a sheet of paper from being contaminated by contact between the print paper and a paper contact arm when a contact force is applied to the sheet of paper by an elastic member, and an image forming apparatus including the same.

2. Description of the Related Art

Print paper includes recording media with various sizes and elasticities, such as paper, film, and photographic paper, which are used as an image forming medium for a device (hereinafter ‘image forming apparatus’), such as a printer, a copier, a fax machine, and a photograph printer, that prints characters and pictures.

An electrophotographic image forming apparatus forms an electrostatic latent image by scanning laser onto a photosensitive medium charged to a particular electric potential. The electrostatic latent image is developed to a toner image of a predetermined color by a developing unit. A monochrome image or a color image is printed on a sheet of print paper by transferring and fixing the toner image to the sheet of print paper. The paper to which the toner image has been fixed is discharged through a discharging path.

In the electrophotographic image forming apparatus, the sheet of print paper is transferred by a plurality of rollers. A plurality of sensors sense whether the sheet of print paper is properly transferred.

These sensors include a non-contact type sensor that determines whether a sheet of print paper is present on a paper path based on the amount of light that passes through the sheet of print paper, and a contact type sensor that detects whether a sheet of print paper is discharged through a discharging path by directly contacting the surface of the print paper with a leading end portion of a print contact arm.

Japanese Patent Laid-Open Publication Nos. 1995-144789 and 1998-59582 both disclose contact type sensors. Each of the contact type sensors includes a paper contact arm that touches a surface of a print paper, a sensor operating arm that opens and closes an optical sensor engaging the paper contact arm, and a spring that returns the paper contact arm back to an initial position by an elastic force.

The contact type sensor may be more advantageous than the non-contact type sensor in terms of cost, reliability, and accuracy. However, since the surface of print paper is heated for transferring or fixing the toner image thereon, the paper contact arm directly touching the surface of the heated print paper may result in contamination by toner particles adhering thereto.

When the elastic force of an elastic member that returns the paper contact arm back to the initial position is excessive, the surface of the print paper is likely to be contaminated. When the elastic force is weak, the paper contact arm cannot properly be returned back to the initial position, thereby causing a paper jam.

Accordingly, a need exists for an image forming apparatus having an improved paper detecting device that substantially prevents paper from being contaminated by contact between the print paper and a paper contact arm.

### SUMMARY OF THE INVENTION

The present invention provides a paper detecting device and an image forming apparatus including the same, in which a contact force regulating unit regulates the contact force within a predetermined range by generating a rotational force in the direction opposite to the direction of an elastic force of an elastic member when a paper contact arm is returned back to its initial position by an elastic member.

According to an aspect of the present invention, a paper detecting device includes a paper contact arm, a first end of which contacts a surface of a sheet of print paper and a second end being connected to a rotating member. The paper contact arm rotates about the rotating member due to the restitution force of the detected sheet of print paper. A sensor unit senses the rotation of the paper contact arm. An elastic member elastically biases the paper contact arm in the direction in which the paper contact arm contacts the sheet of print paper. A contact force regulating unit generates a rotational force in the direction opposite to the direction of an elastic force by the elastic member and regulates the magnitude of a contact force between the paper contact arm and the sheet of print paper.

According to another aspect of the present invention, an image forming apparatus includes a print unit that transfers a toner image on a sheet of print paper using an electrophotographic method. Fixing rollers face each other and fix the toner image onto the sheet of print paper by applying heat and pressure to the toner image while the fixing rollers are rotated. A paper contact arm elastically contacts the sheet of print paper discharged from the fixing rollers and is rotated about a rotating member due to the restitution force of the sheet of print paper. A sensor unit senses the rotation of the paper contact arm. An elastic member elastically biases the paper contact arm in the direction in which the paper contact arm contacts the sheet of print paper. A contact force regulating unit generates a rotational force in the direction opposite to the direction of an elastic force by the elastic member and regulates the magnitude of a contact force between the paper contact arm and the sheet of print paper.

The contact force regulating unit may be a weight and the center of mass of the weight may be eccentrically located on a upper side of the rotating member such that the rotational force in the direction opposite to the direction of the elastic force by the elastic member may be generated by dead load of the weight.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings, in which:

FIG. 1 is a side view schematically showing a structure of an image forming apparatus according to an exemplary embodiment of the present invention;

FIG. 2 is a perspective view of a part D of FIG. 1;

FIG. 3 is a plan view of the part D of FIG. 1;

FIG. 4 is an elevational view in partial cross section of the paper detecting device identified as a part E in FIG. 2;

FIG. 5 is a perspective view of a paper detecting device according to an exemplary embodiment of the present invention;

FIG. 6 is a free-body diagram of a part F of FIG. 5 when the contact force pressing a sheet of print paper downwardly is applied;

FIG. 7 is a free-body diagram of the part F of FIG. 5 when the contact force pressing a sheet of print paper upwardly is applied; and

FIG. 8 is a graph of the magnitude of the applied moments versus the rotation angle in the paper detecting device of FIG. 5.

Throughout the drawings, like reference numerals will be understood to refer to like parts, components and structures.

### DETAILED DESCRIPTION OF EXEMPLARY EMBODIMENTS

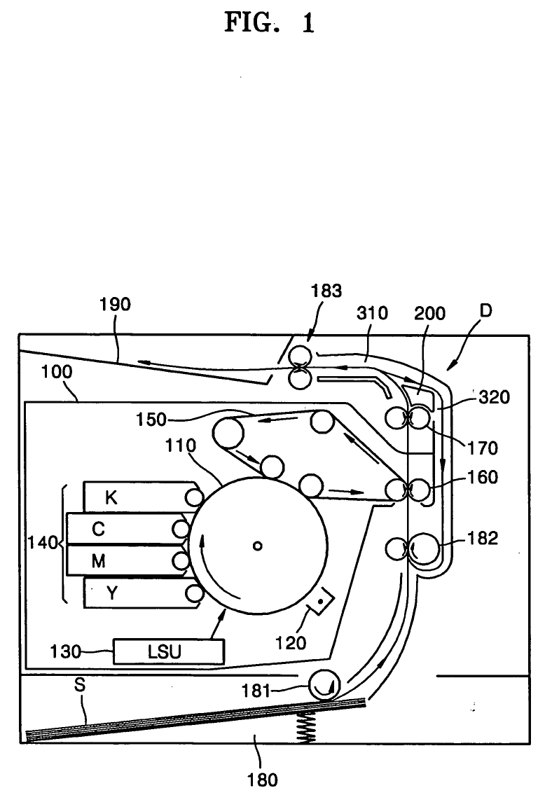

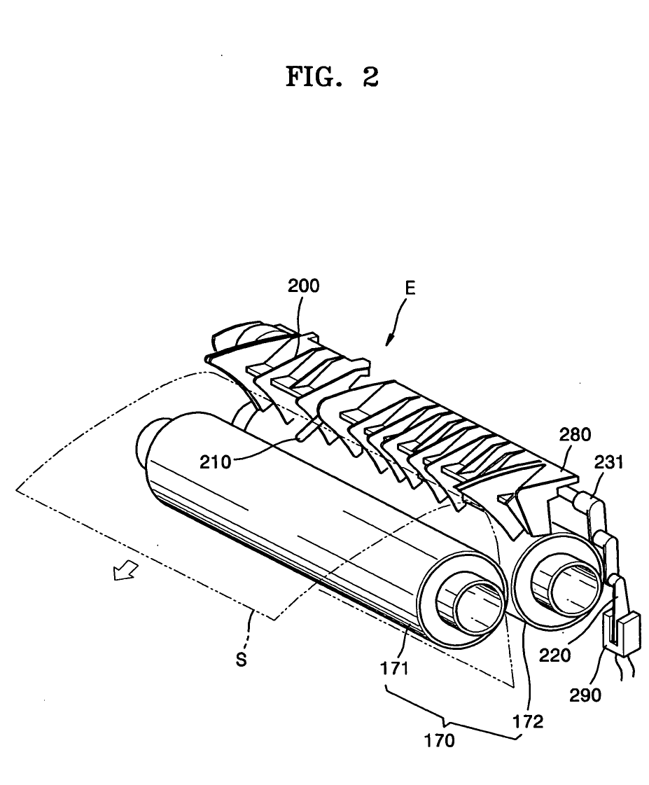

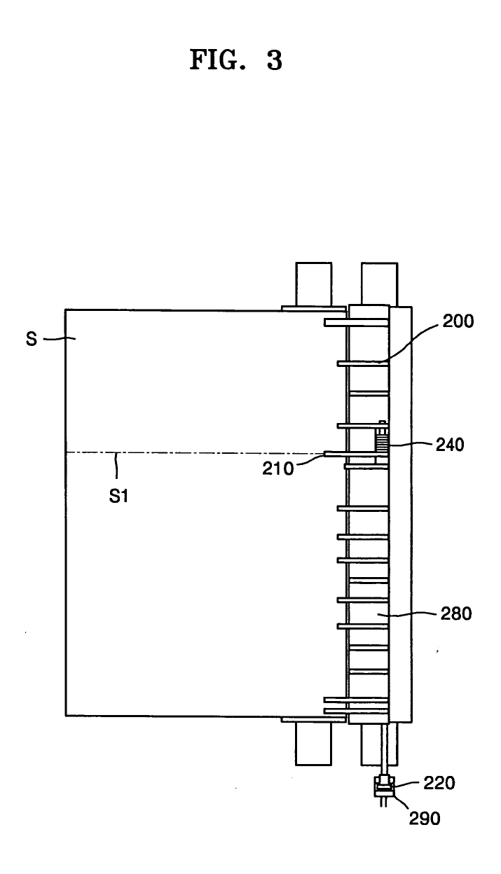

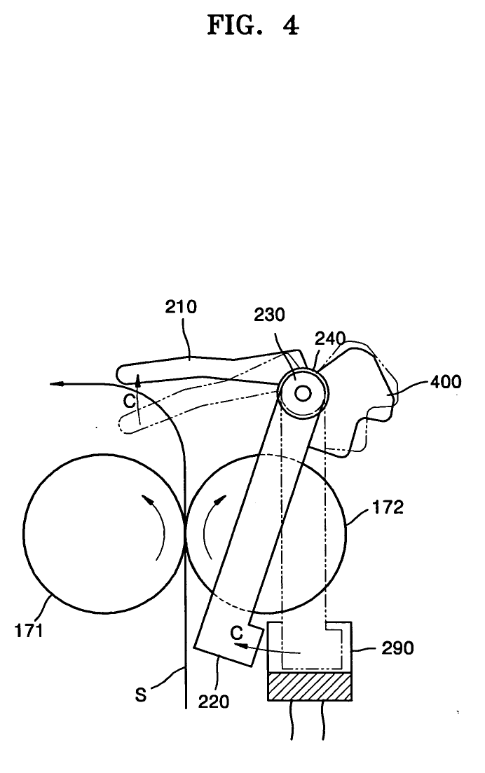

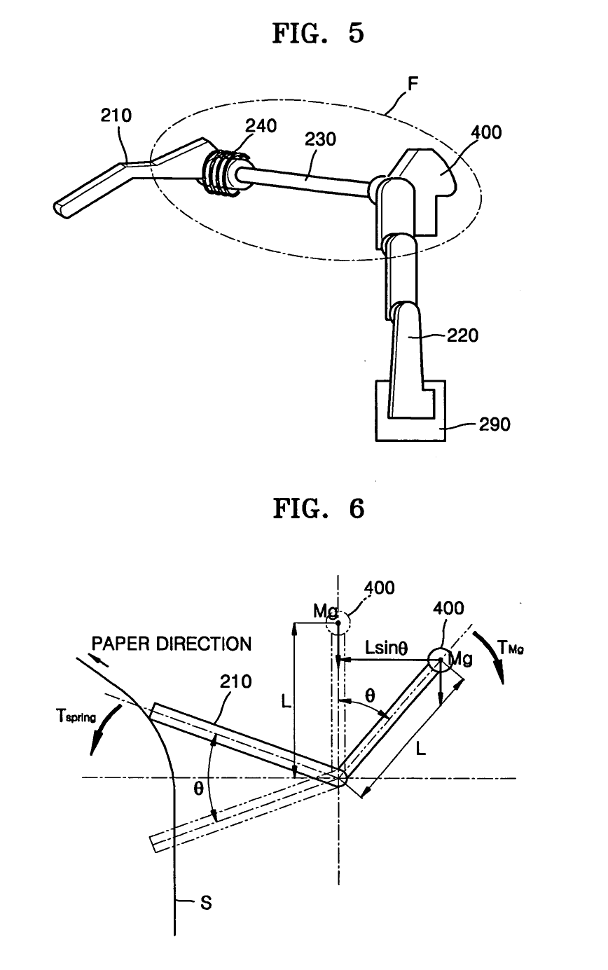

FIG. 1 is a side view schematically showing a structure of an image forming apparatus according to an exemplary embodiment of the present invention. FIG. 2 is a perspective view of a part D of FIG. 1. FIG. 3 is a plan view of a part D of FIG. 1. FIG. 4 is an elevational view in partial cross section of the paper detecting device identified as part E in FIG. 2. FIG. 5 is a perspective view of a paper detecting device according to an exemplary embodiment of the present invention.

Referring to FIGS. 1 and 2, a print unit 100 transfers a toner image onto a sheet of print paper S using an electrophotographic method, and includes a first fixing roller 171, a second fixing roller 172, a discharging path 310, and a reversing path 320. Reference numerals 180, 181, and 182 denote a paper feed cassette, a pick-up roller, and a feed roller, respectively.

The print unit 100 includes a charger 120, a laser scanning unit (LSU) 130, a photosensitive drum 110, a plurality of developing units 140, a transfer belt 150, and a transfer roller 160. According to an exemplary embodiment of the present invention, the print unit 100 is preferably capable of printing a color image and includes four developing units 140, each containing black (K), cyan (C), magenta (M), and yellow (Y) developers.

In the image forming process of the above print unit 100, the charger 120 charges the surface of the photosensitive drum 110 to a particular electric potential. Then, the LSU 130 scans light corresponding to, for example, yellow color image data, onto the photosensitive drum 110. A yellow (Y) electrostatic latent image is formed due to a relative potential difference between a portion where the light is scanned and a portion that is not exposed to the light. The electrostatic latent image is developed to a yellow (Y) toner image by a developing unit 140Y that supplies a developer to the electrostatic latent image. The yellow (Y) toner image is transferred to the transfer belt 150.

After the yellow (Y) toner image is transferred to the transfer belt 150, magenta (M), cyan (C), and black (K) toner images, which are formed in the same fashion as the yellow toner image, are sequentially transferred onto the transfer belt 150 to be overlapped with one another. Consequently, a color toner image is completely formed on the transfer belt 150. A sheet of print paper S is discharged from the paper feed cassette 180 by the pick-up roller 181, and then transferred by the feed roller 182. When a leading end of the color toner image arrives at a location where the transfer belt 150 and the transfer roller 160 face each other, the sheet of print paper S timely arrives at the location where the transfer belt 150 and the transfer roller 160 face each other. The color toner image is then transferred onto the print paper S.

The transferred print paper S enters between the first fixing roller 171 and the second fixing roller 172. The first and second fixing rollers 171 and 172 rotate while contacting and pressing each other. At least one of the first and second fixing rollers 171 and 172 includes a heater. The first and second fixing rollers 171 and 172 are referred to as a fixing roller 170 hereafter. The fixing roller 170 fixes the color toner image to the sheet of print paper S by applying heat and pressure to the print paper S, thereby finishing printing of the color toner image.

In the above exemplary embodiment, a multi-pass type print unit having a single photosensitive drum and a single LSU has been described as an example of the present invention. However, the present invention is not limited solely to this structure, but various types of electrophotographic print units to print an image may be employed with the present invention.

The discharging path 310 connects the fixing roller 170 and a discharging roller 183. The print paper S on which the color toner image has been printed is discharged to a discharge tray 190 through the discharging path 310. The reversing path 320 for printing on both sides of print paper S may also be included. The print paper S on which an image has been printed on one side is reversed and transferred to the print unit through the reversing path 320 to print an image on the other side of the print paper S. The reversing path 320 is branched off from the discharging path 310 and extends to the feed roller 182 of the print unit 100 that feeds a sheet of print paper S. An individual driving unit (not shown) may be installed on the discharging path 310 and the reversing path 320 to feed the sheet of print paper S.

In the operation of the image forming apparatus, the print paper S is drawn out from the paper feed cassette 180 by the pick-up roller 181, or the print paper S is provided through the reversing path 320 for duplex printing. The print paper S is inserted between the transfer belt 150 and the transfer roller 160 by the feed roller 182. When passing through the charging, scanning, developing, and transferring processes, the color toner image is transferred onto the transfer belt 150. Then, the color toner image is transferred from the transfer belt 150 to the sheet of print paper S. The print paper S, onto which the color toner image is transferred, is inserted in the fixing roller 170 and discharged to the discharging path 310 after the fixing process in which heat and pressure are applied.

Referring to FIGS. 2 through 4, a guide member 200 guides the sheet of print paper S discharged from the fixing roller 170 to the discharging path 310. As an exemplary embodiment, a frame 280 extending in a widthwise direction of the print paper S is disposed above the second fixing roller 172. The guide member 200 is preferably integrally formed with the frame 280.

A paper contact arm 210 is pivotally connected to the frame 280. As an exemplary embodiment, a rotating member 230 is pivotally connected to the frame 280, and the paper contact arm 210 is connected to the rotating member 230. A leading end portion of the paper contact arm 210 extends to where a sheet of print paper S is discharged from the fixing roller 170. The sheet of print paper S discharged from the fixing roller 170 pushes the paper contact arm 210, thereby causing the paper contact arm to rotate.

A sensor unit senses the rotation of the paper contact arm 210 to detect the print paper S. According to an exemplary embodiment of the present invention, the sensor unit includes a sensor 290 that detects print paper S, and a sensor operating arm 220 that opens and closes the sensor depending on whether the paper contact arm 210 touches the print paper S while rotating with the paper contact arm 210.

The rotation member 230 may be an axis pivotally connected to a boss, similar to a bearing, fixed to the frame 280. The sensor operating arm 220 is connected to an end portion 231 of the rotating member 230. The sensor operating arm 220 rotates together with the paper contact arm 210 to detect whether the sheet of print paper S is discharged from the fixing roller 170. The sensor 290 is turned on and off by the sensor operating arm 220 that rotates. The sensor 290 may be an optical sensor or micro-switch.

As an exemplary embodiment of the optical sensor, a light emitting sensor and a light receiving sensor are respectively installed on both sides of a light shielding portion formed on one end portion of the sensor operating arm 220. The light shielding portion shields light from the light emitting sensor to the light receiving sensor. The present invention is not limited to such structure, but the light shielding portion may reflect light from the light emitting sensor to the light receiving sensor.

The sensor 290 may be used to determine a paper jam. For example, if the sensor 290 does not detect the sheet of print paper S within a predetermined period of time after the sheet of print paper S is drawn out from the paper feed cassette 180, it is determined that a paper jam has occurred in a paper feeding path between the paper feed cassette 180 and the fixing roller 170. When the sensor 290 stays in an ON state for a predetermined period of time after detecting the sheet of print paper S, it is determined that a paper jam has occurred in the fixing roller 170 or the discharging path 310.

Referring to FIG. 3, an elastic member 240 is installed to elastically bias the paper contact arm 210 in the direction in which the paper contact arm contacts the sheet of print paper S. The elastic member 240 may be a torsion spring concentrically connected to the rotating member 230. The elastic member 240 provides contact force against the print paper, and returns the paper contact arm 210 back to the initial position.

One end of the torsion spring is connected to the paper contact arm 210. The other end of the torsion spring may be connected to the frame 280 of the image forming apparatus. However, the present invention is not limited to such structure, but an elastic medium, such as a pressed coil spring, a leaf spring, and rubber, may be installed to return the paper contact arm 210 back to the initial position.

When non-linear elements, such as a damping force, are neglected, the magnitude of the elastic force is the modulus of elasticity multiplied by the displacement rotation angle. The elastic force is increased in proportion to the increase in the displacement rotation angle, which increases the contact force against the print paper S. A contact force regulating unit that regulates the contact force with respect to the print paper S is installed to generate a rotational force in the direction opposite to the direction of the elastic force of the elastic member 240. A weight 400 is installed as an example of the contact force regulating unit. As an example, the weight 400 is eccentrically positioned on the upper side of the rotating member 230 such that the rotational force in the direction opposite to the direction of the elastic force of the elastic member 240 is generated due to the dead load of the weight 400.

The paper contact arm 210 contacts an image area of the print paper S. The image area is a portion where an image is actually printed, excluding the top, bottom, and lateral margins. Sheets of print paper of various widths and sizes are used to print an image. To contact a sheet of print paper S with the minimum width, the paper contact arm 210 may be located at the center in the widthwise direction of the sheet of print paper S.

Toner used for an electrophotographic image forming apparatus is commonly resin having a predetermined color. When heated toner on a sheet of print paper is not sufficiently cooled, the toner on the print paper may be sticky. When an image is printed on the back side of a printed sheet of print paper S or an image is printed on both sides of a sheet of print paper S, the toner fixed to the sheet of print paper S is melted again due to heat applied by the fixing roller 170. When an image is printed on both sides of the sheet of print paper S, the back side of the print paper S may be contaminated because the leading end portion of the paper contact arm 210 touches the image area of the back side of the print paper S. When an image is printed on the back side of the printed sheet of print paper S, the toner on the printed sheet softened by the heat of the fixing roller 170 contaminates the leading end portion of the paper contact arm 210, so that the sheet of print paper S is secondly contaminated.

To avoid contamination of a sheet of print paper, the contact force needs to be reduced. The modulus of elasticity of a spring must be reduced within the range in which the minimum contact force is ensured. However, if the modulus of elasticity of the elastic member 240 is low, since the elastic member 240 is manufactured and assembled within a narrow tolerance range, the mass-productivity and efficiency are deteriorated. When an elastic member 240 having a large modulus of elasticity is used while the contact force regulating member reduces the contact force of the elastic member 240, the elastic member 240 may be manufactured and assembled in an extended tolerance range and thereby the mass-productivity may be increased.

The elastic force of the elastic member 240 is obtained by multiplying the modulus of elasticity by the rotation angle. The elastic force increases in proportion to the rotation angle of the paper contact arm 210 applied to the sheet of print paper S. Because the moduli of elasticity in the widthwise direction and in the lengthwise direction are different according to the sizes and materials of the sheets of print paper, the rotation angle of the paper contact arm 210 is changed. Because the contact force sensitively varies depending on changes in the rotation angle due to the various sizes and materials of the sheets of print paper, the contact force regulating unit needs to be able to actively meet the changes in the rotation angle.

The contact force by the dead load of the paper contact arm 210 corresponds to a rotation moment that is obtained by multiplying a horizontal projection distance between the center of the rotating member 230 and the center of mass of the paper contact arm 210 by the dead load of the paper contact arm 210. The horizontal projection distance denotes a distance perpendicular to gravitational direction. The magnitude of the contact force due to the dead load of the paper contact arm 210 is maximized when the paper contact arm 210 is positioned substantially perpendicularly to the gravitational direction. The magnitude of the contact force due to the dead load of the paper contact arm 210 is further reduced as the paper contact arm 210 rotates further. The contact force becomes 0 when the paper contact arm 210 stands substantially parallel to the gravitational direction. Because the elastic force due to the dead load is not applied when the paper contact arm 210 stands parallel to the gravitational direction, the paper contact arm 210 may not be returned, and thus a paper jam may occur. Therefore, it is desired to prevent the paper contact arm 210 from not returning back and obtain a predetermined contact force by using the elastic force of the elastic member 240 rather than only depending on the dead load of the paper contact arm 210. However, the contact force of the elastic member 240 that excessively increases in proportion to the rotation angle causes problems such as difficulty in using a variety of paper, paper damage, and contamination of a printing surface. The contact force regulating unit regulates the excessive contact force.

Because the torsion spring is installed while being pressed with an initial displacement, the elastic force by the torsion spring is applied to the paper contact arm 210 even before the paper contact arm 210 rotates. Such an initial elastic force corresponds to a constant and is a small value, so that the initial elastic force may be neglected when the magnitude of the change of the contact force is examined.

When the material of the paper contact arm 210 is synthetic resin, because the dead load of the paper contact arm 210 is small and the horizontal projection distance between the rotating member 230 and the center of mass of the paper contact arm 210 includes a cosine term, the magnitude of the change is small (since cos θ=≈1 when θ is a minute angle.) Thus, rotational force due to the dead load of the paper contact arm 210 may be neglected when the magnitude of the change of the contact force is examined.

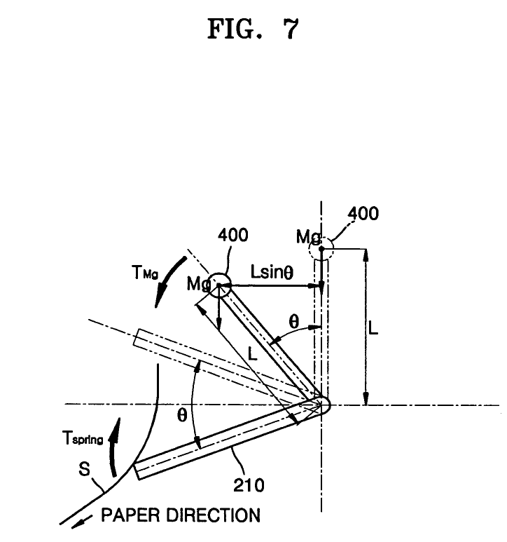

FIG. 6 is a free-body diagram of a part F of FIG. 5 when the contact force pressing a sheet of print paper downwardly is applied to the print paper. FIG. 7 is a free-body diagram of the part F of FIG. 5 when the contact force raising a sheet of print paper upwardly is applied to the print paper. The dotted lines indicate that the paper contact arm 210 and the weight are at the initial positions before rotating. In the free-body diagrams of FIGS. 6 and 7, the equilibrium equation for rotation moment is as follows. The equilibrium equation for rotation moment is a function with respect to θ, which is an angle rotated from the initial position of the paper contact arm 210 before rotating to the position where the paper contact arm 210 detects a sheet of print paper.
ΣT=T_{spring}−T_{M g}=kθ−M g L sin θ

T_{spring}: elastic moment by the torsion spring

T_{M g}: rotational moment by the dead load of the weight

K: torsion elasticity modulus of the torsion spring

θ: the angle rotated from the initial position of the paper contact arm

M: mass of the weight

g: gravitational acceleration

L: eccentricity of the center of mass of the weight

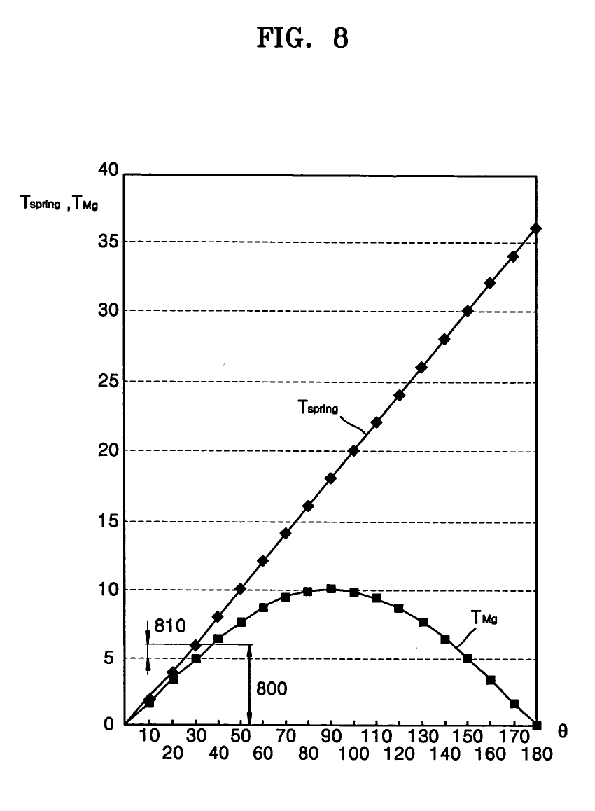

FIG. 8 is a graph with rotation angles θ (degrees) on the horizontal axis and T_{spring} and T_{M g} on the vertical axis. Given that k=0.2 (N·m/degree) and M g L=10 (N·m), the moment value is shown as an example.

Referring to FIG. 8, if θ=30° and the weight is not installed, the elastic moment (numeral reference 800) corresponding to an equation that T_{spring}=6 (N·m) is applied to the sheet of print paper. If θ=30° and the weight is installed, the elastic moment (numeral reference 810) corresponding to an equation that T_{spring}−T_{M g}=6−5=1 (N·m) is applied to the sheet of print paper.

When the rotation angle θ is small, the value of sin θ is small but increases in proportional to the rotation angle since sin θ≈θ. The increasing slope of the spring elastic moment T_{spring} due to the rotation angle may be reduced by appropriately selecting ML which is the mass of the weight multiplied by the eccentric distance with respect to the torsion elasticity modulus.

As the rotation angle θ is increased, the sin θ is almost a constant value (sin 90°=1). Therefore, it is difficult to reduce the increasing slope of the spring elastic moment T_{spring} by controlling ML. However, since the value of sin θ is large, the value of M g L sin θ may be increased. The value of ML may be relatively small. Thus cost and space for installing the weight may be relatively reduced.

That is, it is advantageous for reducing the increasing slope of the spring elastic moment T_{spring} to install the weight vertically in the upper direction, and it is advantageous for reducing the magnitude of the spring elastic moment T_{spring} in small installation space to install the weight horizontally in the lateral direction.

Since the contact force that presses a sheet of print paper downwardly is generated only when the value obtained from an equation that ΣT=T_{spring}−T_{M g}=k θ−M g L sin θ is positive, the initial positions of k, ML, and the weight are carefully determined.

Although the above exemplary embodiment has been described on the assumption that the contact force that presses a sheet of print paper downwardlys is applied, the present invention is not limited thereto, and the contact force that raises a sheet of print paper upwardly may be applied. Referring to FIG. 7, the torsion spring is installed in the direction in which the torsion spring lifts the paper contact arm 210 upwardly. T_{spring}, that is the spring elastic moment, is applied in the clockwise direction, T_{M g} is applied in the counterclockwise direction, and the rotation angle θ is positive when the paper contact arm 210 rotates in the counterclockwise direction. However, the equilibrium equations for rotation moment of FIGS. 6 and 7 are the same, and thus the changes of T_{spring} and T_{M g} with respect to the rotation angle θ is substantially identical with that shown in FIG. 8.

In the exemplary embodiment described above, it is assumed that the initial rotation moment due to the initial installation force of the spring and the dead loads of the paper contact arm 210 and the sensor operating arm 220 at the initial positions prior to rotating is negligible. However, the initial rotation moment may be considered for the rotation moment equilibrium equation to remove the initial rotation moment due to the initial installation force of the spring and the dead loads of the paper contact arm 210 and the sensor operating arm 220 at the initial positions prior to rotating. The initial rotation moment may be removed when the weight is installed predetermined degrees apart from a reference axis in the horizontal direction when a vertical axis above the weight is set to be the reference axis.

According to the exemplary embodiments of the present invention, the center of mass of the weight is located predetermined degrees apart from the upward vertical axis of the rotating member 230, and thus, the rotational force due to the elastic force by the elastic member 240 and the dead loads of the paper contact arm 210 and sensor operating arm 220 is removed when the paper contact arm 210 is at the initial position prior to rotating.

Although the above exemplary embodiments have been described as including one paper contact arm 210, the present invention is not limited thereto, and a plurality of paper contact arms may be installed and a plurality of paper detecting devices may be installed in an image forming apparatus.

According to exemplary embodiments of the present invention as described above, a paper detecting device and an image forming apparatus including the same prevent paper jams by returning a paper contact arm to its initial position using an elastic member, thereby avoiding damage and contamination of a sheet of paper by regulating paper contact force within a predetermined range using a contact force regulating unit. Furthermore, the structure of the paper detecting device and the image forming apparatus including the same are simple, such that the mass-productivity thereof may be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A paper detecting device, comprising:
a paper contact arm having a first end adapted to contact a surface of a sheet of paper and a second side connected to a rotating member, the paper contact arm being rotated about the rotating member due to the restitution force of the detected sheet of paper;
a sensor unit that senses the rotation of the paper contact arm;
an elastic member that elastically biases the paper contact arm in the direction in which the paper contact arm contacts the sheet of paper; and
a contact force regulating unit that generates a rotational force in the direction opposite to the direction of an elastic force by the elastic member and regulates the magnitude of a contact force between the paper contact arm and the sheet of paper.

2. The paper detecting device of claim 1, wherein the sensor unit includes
a sensor that detects the sheet of paper; and
a sensor operating arm that opens and closes the sensor according to whether the paper contact arm contacts the sheet of paper, the sensor operating arm rotating together with the paper contact arm.

3. The paper detecting device of claim 2, wherein
the sensor is an optical sensor including a light emitting sensor and a light receiving sensor that are respectively disposed apart from each other on both sides of a light shielding portion formed on one end portion of the sensor operating arm.

4. The paper detecting device of claim 1, wherein
the elastic member is a torsion spring concentrically connected to the rotating member.

5. The paper detecting device of claim 1, wherein
the contact force regulating unit is a weight and the center of mass of the weight is eccentrically located on an upper side of the rotating member.

6. The paper detecting device of claim 5, wherein
the rotational force generated by the dead load weight is in a first direction opposite to a second direction of the elastic force generated by the elastic member.

7. The paper detecting device of claim 6, wherein
the center of mass of the weight is located predetermined degrees apart from a vertical axis through the rotating member such that the rotational force due to the elastic force generated by the elastic member and the dead load of the sensor operating arm and the paper contact arm when the paper contact arm is at an initial position before rotating is removed.

8. An image forming apparatus, comprising:
a print unit that transfers a toner image onto a sheet of paper using an electrophotographic method;
fixing rollers disposed in the image forming apparatus face each other and fix the toner image onto the sheet of paper by applying heat and pressure to the toner image while the fixing rollers are rotated;
a paper contact arm that elastically contacts the sheet of paper discharged from the fixing rollers and is rotated about a rotating member due to the restitution force of the sheet of paper;
a sensor unit that senses the rotation of the paper contact arm;
an elastic member that elastically biases the paper contact arm in the direction in which the paper contact arm contacts the sheet of paper; and
a contact force regulating unit that generates a rotational force in a first direction opposite to a second direction of an elastic force generated by the elastic member, the contact force regulating unit regulates the magnitude of a contact force between the paper contact arm and the sheet of paper.

9. The image forming apparatus of claim 8, wherein the sensor unit includes
a sensor that detects the sheet of paper;
a sensor operating arm that opens and closes the sensor according to whether the paper contact arm contacts the sheet of paper, the sensor operating arm rotating together with the paper contact arm.

10. The image forming apparatus of claim 9, wherein
the sensor is an optical sensor including a light emitting sensor and a light receiving sensor that are respectively disposed apart from each other on both sides of a light shielding portion formed on one end portion of the sensor operating arm.

11. The image forming apparatus of claim 8, wherein
the elastic member is a torsion spring concentrically connected to the rotating member.

12. The image forming apparatus of claim 8, wherein
the contact force regulating unit is a weight and the center of mass of the weight is eccentrically located on an upper side of the rotating member.

13. The image forming apparatus of claim 12, wherein
the rotational force generated by the dead load of the weight is in a first direction substantially opposite to second direction in which the elastic force is generated by the elastic member.

14. The image forming apparatus of claim 13, wherein
the center of mass of the weight is located predetermined degrees apart from a vertical axis through the rotating member such that the rotational force due to the elastic force generated by the elastic member and the dead load of the sensor operating arm and the paper contact arm when the paper contact arm is at an initial position before rotating is removed.
